(19) United States
(12) Patent Application Publication
(10) Pub. No.: US 2012/0019973 A1
(43) Pub. Date: Jan. 26, 2012

(54) METHOD AND APPARATUS FOR GROUNDING A COMPOSITE AIRCRAFT STRUCTURE

(75) Inventors: ADAM SCOTT EHRMANTRAUT, Manassas Park, VA (US); PATRICK DAVIS GARRETT, Warrenton, VA (US); CAYCE MCPHERON BOONE, Manassas, VA (US)

(73) Assignee: AURORA FLIGHT SCIENCES CORPORATION, Manassas, VA (US)

(21) Appl. No.: 13/020,195

(22) Filed: Feb. 3, 2011

Related U.S. Application Data
(60) Provisional application No. 61/354,570, filed on Jun. 14, 2010.

(51) Int. Cl. H05F 3/00; B23P 25/00

(52) U.S. Cl. 361/218; 29/527.2

(57) ABSTRACT

Method and apparatus for installing a grounding fastener in a composite aircraft structure includes structure and/or function for (i) drilling a hole in the composite aircraft structure, the hole dimensioned to provide a clearance fit with respect to the composite structure and the grounding fastener; (ii) coating the grounding fastener with a conductive fluid; (iii) inserting the grounding fastener into the hole such that the grounding fastener is in electrical contact with conductive fibers within the composite structure; (iv) securing the grounding fastener to the composite structure; and (v) attaching a conductive device to the grounding fastener such that the conductive device is in electrical contact with the grounding fastener.

This application claims priority to U.S. provisional patent Appln. No. 61/354,570, filed Jun. 14, 2010, incorporated herein by reference.

### BACKGROUND OF THE INVENTION

1. Field of the Invention

The present invention relates to system, apparatus, and method for electrically grounding a composite aircraft structure.

2. Description of Related Art

Composite materials are well known in the art for use in aircraft structures. The composite structures are much lighter in weight than metal, making their use advantageous in an aircraft structure. However, exposed aircraft surfaces made from composite materials can present problems with respect to attaching other structures thereto.

The composite structure often includes a surface region made of an electrically insulating material and various types of inner region materials which are electrically conductive. Static charge builds up on the surface of the aircraft structure as it flies through the air. Often, the aircraft flies through clouds, winds, or heavy storms, which places large static charges on various parts of the aircraft structure. The static charges build up on the insulating surface until the charge density is sufficiently high to permit discharge to a different part of the aircraft. This creates sparks or electrical arcing from the insulating surface region to the discharge location. The discharge point may be metal screws, sheets of metal, engine mounts, or other portions of the aircraft. A spark of this nature is extremely hot and creates high temperature heating of a localized area in the spark region. A graphite composite structure has very good fatigue properties, but the epoxy part of the composite is susceptible to damage by very high temperatures, such as those produced by an arc. Graphite tends to conduct better at very high temperatures than metal, whereas metal conducts better than graphite at room temperature. At lower temperatures, metal conducts better than the composite, the resistance being lower. When a spark begins to occur and localized heating begins to take place, the composite heats up and conducts much better than metal, thus providing a lower resistance current path for electricity, which creates an even greater heating effect in the composite structure. Similar problems occur from lightning strikes.

A further safety problem may occur when an electrical device such as a pump is attached to a composite structure. A fuse is connected in series with various parts of the pump to cut off the supply of electric current should it become too high. A current that would trip the fuse is referred to as fault current. Under normal circumstances when a fault current exits, the fuse will trip and protect the pump and prevent a fire from starting within the electrical wiring. If the pump is connected by a metal fastener to the composite structure it is possible that arcing or other heating current flow may cause heating at the graphite, thus making it a better conductor than metal at this temperature. The fault current would then begin to flow in the graphite composite structure and bypass the fuse circuit completely. Significant current could flow to the pump bypassing the fuse causing a fire or destruction of the pump. This is even more likely if a lightning strike occurs.

U.S. Pat. No. 4,920,449 to Covey, discloses a method of dealing with the electrical charge-carrying problem with composite structures, by using conductive fasteners. The fasteners are installed into a hole drilled into the composite structure. The ends of the fibers that are exposed in the hole are conductive, but the contact to the fastener is determined by the tolerances for the hole and the resulting contact pressure. This is very difficult to control, and contact may be intermittent. Covey also discloses the use of interference fit fasteners, either cylindrical press fit or self tapping threaded fasteners, which tend to locally damage the resin part of the composite structure. Electrical contact between the conductive fibers and the conductive fastener may fail in a damaged composite structure as the flight loads work the structure.

U.S. Patent Application No. 2007/0270002 to Braden et al. discloses a ground stud installed by transition or clearance fit to avoid structural damage caused by using an interference fit. However, poor electrical connections can occur between the fibers of the composite structure and the conductive fastener unless the fastener is fitted perfectly into the hole. This method is very difficult to control and may increase both production costs and time.

Thus, what is needed is a conductive fastener that will provide a good electrical connection between a composite structure and ground while maintaining structural integrity of the composite structure.

### SUMMARY OF THE INVENTION

It is an advantage of the present invention to overcome the above-noted problems of the related art and to provide system, apparatus, and method for electrically grounding a composite aircraft structure, which is electrically conductive yet mechanically strong.

According to a first aspect of the present invention, a novel combination of structure and/or steps are provided for installing a grounding fastener in a composite aircraft structure includes structure and/or function for (i) drilling a hole in the composite aircraft structure, the hole dimensioned to provide a clearance fit with respect to the composite structure and the grounding fastener; (ii) coating the grounding fastener with a conductive fluid; (iii) inserting the grounding fastener into the hole such that the grounding fastener is in electrical contact with conductive fibers within the composite structure; (iv) securing the grounding fastener to the composite structure; and (v) attaching a conductive device to the grounding fastener such that the conductive device is in electrical contact with the grounding fastener.

According to a second aspect of the present invention, a novel combination of structure and/or steps are provided for aircraft composite structure grounding apparatus, includes the aircraft composite structure having an upper surface, a lower surface, and an interior region, the interior region having a fastener hole therein. Conductive composite fibers are disposed within the hole with a plurality of voids therebetween. The hole is dimensioned to provide a clearance fit with respect to the composite structure and a grounding fastener. The grounding fastener is disposed within the fastener hole in the clearance fit with respect to the composite structure. Conductive fluid is disposed in the fastener hole (i) to substantially fill the voids between the composite fiber and (ii) in electrical contact with the grounding fastener and the composite structure. A conductive element is provided for conducting electrical charge away from the composite structure and the grounding fastener.

### BRIEF DESCRIPTION OF THE DRAWINGS

Exemplary embodiments of the presently preferred features of the present invention will now be described with reference to the accompanying drawings.

FIG. 1 is a schematic cross-sectional diagram according to a first embodiment of the subject invention.

FIG. 2 is a schematic cross-sectional diagram according to a second embodiment of the subject invention.

FIG. 3 is a schematic cross-sectional diagram according to a third embodiment of the subject invention.

FIG. 4 is a schematic cross-sectional diagram according to a fourth embodiment of the subject invention.

### DETAILED DESCRIPTION OF THE PRESENTLY PREFERRED EXEMPLARY EMBODIMENTS

### 1. Introduction

The present invention will now be described with respect to several embodiments in which one or more grounding fasteners is/are disposed in a composite structure so as to form a good electrical connection with said composite material. However, the present invention may find applicability in other devices/systems utilizing composite materials where a need to prevent the build up of static charge on the surface of the composite material is desirable.

Briefly, the preferred embodiments of the present invention provide for a grounding fastener that is coated in an electrically conductive fluid and then is disposed through a composite structure and forming an electrical connection with the composite structure.

### 2. The Structure of the Preferred Embodiment

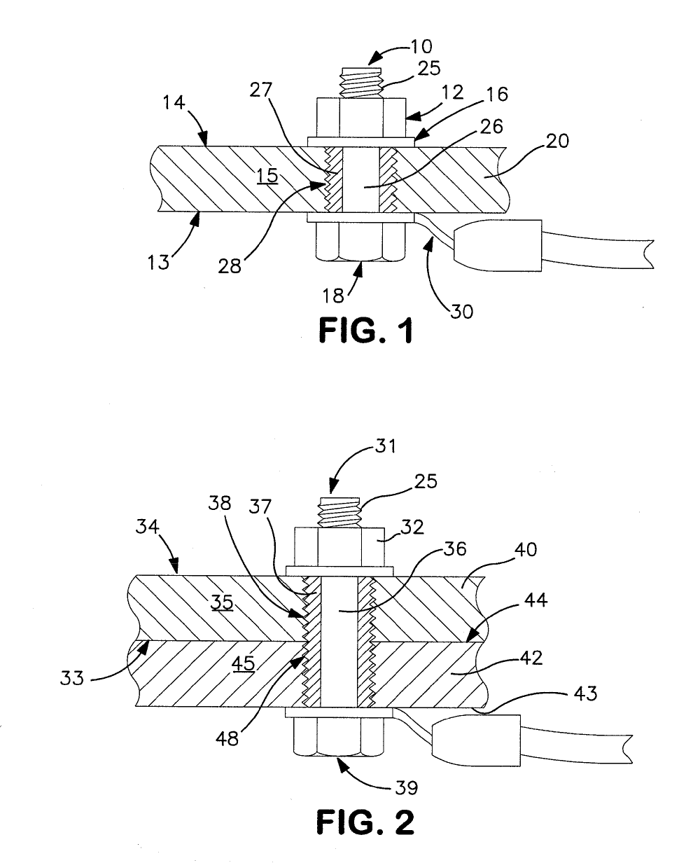

With reference to FIG. 1, a composite structure 20 is shown with a fastener 10 disposed therethrough. The composite structure 20 includes an upper surface region 14, an inner region 15, and a lower surface region 13. This composite structure 20 can be a graphite/epoxy structure, a matrix of thermoplastic or thermoset polymer reinforced with carbon fibers, metal filaments, metal-coated fibers, or metallic meshes, or any other composite material usable in aircraft structures. The upper and lower surface regions 14 and 13, respectively, of the composite structure 20 are predominantly electrically insulating, while the inner region 15 contains fibers which are substantially electrically conductive. As the aircraft flies through the air, a static charge may build up on the surface regions 13 and 14. The surface regions 13 and 14 and the inner region 15 may also be charged by a lightning strike.

The fastener 10 has a head 18, threads 25 disposed at the distal end of fastener 10 opposite head 18, and a shank 26 disposed between the head 18 and the threads 25 and, preferably, along the portion of the fastener 10 that is in contact with the composite structure 20. A nut 12 is secured to the fastener 10 at the threads 25. Preferably, the threads 25 do not contact the conductive fibers within the interior region 15, preferably only the shank portion of the fastener touches the hole. Washers 16 can be placed between the fastener head 18 and the nut 12 at the respective surface regions 14 and 13 of the composite structure 20, respectively. The fastener 10 is tightened on both the head 18 and the nut 12 according to the torque specified by industry standards, according to bolt type. A conductive device 30 can be connected to the fastener 10, if desired, preferably by placing the conductive device 30 under the bolt head 18 prior to tightening. The conductive device 30 can be connected to other fasteners, system ground, or a different voltage potential.

As mentioned above, the fastener shank 26 contacts the inner region 15 of the composite structure 20, thereby creating a contact area 28 between the inner region 15 of the composite structure 20 and the fastener 10. The contact area 28 between the composite structure 20 and the fastener 10 can be significantly increased by the use of a conductive fluid 27. Preferably, a conductive fluid 27 is a curable fluid which hardens after installation to create a permanent conductive interface between fastener 10 and composite structure 20. In one embodiment, the conductive fluid 27 can be used to coat the fastener 10 prior to installing in the composite structure 20. However, conductive fluid 27 can be administered at any time in order to form a good electrical connection between the fastener 10 and the inner region 15 of the composite structure 20. For example, the conductive fluid 27 can be applied to the fastener 10 before, during, or after installation, by means of hand-coating, tool-coating, injection, caulking, etc. Likewise, the conductive fluid 27 may be applied to the fibers themselves, before, during, or after installation, by means of hand-coating, tool-coating, injection, caulking, etc. Of course, the application of the conductive fluid 27 may be carried out by any combination of the above-described methods, in any order desired, depending on the particular fastener/composite structures involved. Preferably, the conductive fluid 27 should be applied so as to fully wet the fibers of inner region 15 and thus increase the contact area between the fastener 10 and the composite structure 20. The increased contact area significantly lowers resistance between the fastener and the composite structure, and permits much higher currents to pass from the composite structure 20 to the fastener 10, at lower temperatures. The method and apparatus may be used without a conductive strap, for example, to join together two composite structures.

As charge builds up on the surface regions 14 and 13, they are electrically coupled by the washer 16 and the nut 12 to the fastener 10, and discharged through the conductive device 30, without substantial arcing. Further, electrical charge or current which is within the inner region 15 due to fault current, stray electric charges, lightning strikes, etc., is conducted through threaded fastener 10 to the conductive device 30 without arcing.

The fit between the composite structure 20 and the fastener 10 is most preferably a clearance fit. Thus, the shank 26 is only in fairly loose contact with all portions of the composite structure, in the absence of the conductive fluid 27. In contrast, an interference fit (wherein the fastener is in firm contact with the surrounding composite structure) has been known to cause cracking or other structural damage to the composite structure. In a clearance fit, the hole is made slightly larger than the fastener so that the fastener may be placed through the hole for connecting to a nut at the other side. Preferably the clearance fit hole should be drilled substantially between 0.001 and 0.007 inches larger than the diameter of the fastener shank 26, more preferably the clearance fit hole should be drilled substantially between 0.002 and 0.006 inches larger than the diameter of the fastener shank 26, even more preferably the clearance fit hole should be drilled substantially between 0.003 and 0.005 inches larger than the diameter of the fastener shank 26, and most preferably the clearance fit hole should be drilled substantially about 0.004 inches larger than the diameter of the fastener shank 26. A clearance fit, even if machined to high tolerances, permits small air gaps or voids to exist between the inner region 15 of the composite structure 20 and the fastener 10. The conductive fluid 27 fills these gaps, providing a large contact area between the fastener 10 and the composite structure 20, as well as reducing the risk of structural damage caused by an interference fit.

According to one embodiment, when installing the fastener 10, a hole is drilled in the composite structure 20 but this hole is made somewhat larger than the diameter of the fastener 10. Preferably the hole should be drilled substantially between 0.001 and 0.007 inches larger than the diameter of the fastener shank 26, more preferably the hole should be drilled substantially between 0.002 and 0.006 inches larger than the diameter of the fastener shank 26, even more preferably the hole should be drilled substantially between 0.003 and 0.005 inches larger than the diameter of the fastener shank 26, and most preferably the hole should be drilled substantially about 0.004 inches larger than the diameter of the fastener shank 26 The threaded fastener 10 is then coated with the conductive fluid 27 and passed through the recently-drilled hole in the structure 20. The fastener 10 is tightened on both the head 18 and the nut 12, to secure it to the structure 20. The conductive fluid 27 can then adhere to and into the fibers of the inner region 15. This provides a solid electrical connection between the threaded fastener 10 and the inner region 15 of the composite structure 20, with substantially no significant voids therebetween. This operates to substantially mitigate or prevent arcing between the composite structure and any portion of the fastener.

Additionally, conductive fluid 27 can comprise an adhesive such as an epoxy, polysulfide rubber fuel tank sealant, or any other electrically conductive adhesive known in the art. The conductive fluid 27 can also be selected as an adhesive having more flexibility than the local part of the composite structure 20, thus maintaining the electrical contact as the structure deforms during flight. Preferably, a conductive fluid 27 with acceptable conduction and flexibility properties is MG Chemicals 8331 Silver-Filled Epoxy, Masterbond Polymer System EP79 Silver-coated nickel-filled epoxy, or any other adhesive known in the art to provide sufficient conductivity and flexibility.

In another embodiment of the present invention, FIG. 2 shows that a composite structure 40 may be fastened to a second structure 42 in a manner similar to that described above. In this embodiment, the second structure 42 can be a composite structure, a metal structure, or any other structure known to be used in the construction of aircraft. Thus, the composite structure 40 has an upper region 34, a lower region 33, and an interior region 35. The second structure 42 has an upper region 44, a lower region 43, and an interior region 45. A fastener 31 has a nut 32, a head 39, and fastener shank 36. A conductive fluid 37 fills a contact area 38 between the shank 36 of the fastener 31 and the interior 35 of the composite structure 40. Additionally, if the second structure 42 is also a composite structure, then the conductive fluid 37 also fills the contact area 48 between the shank 36 of the fastener 31 and the interior 45 of the second structure 42.

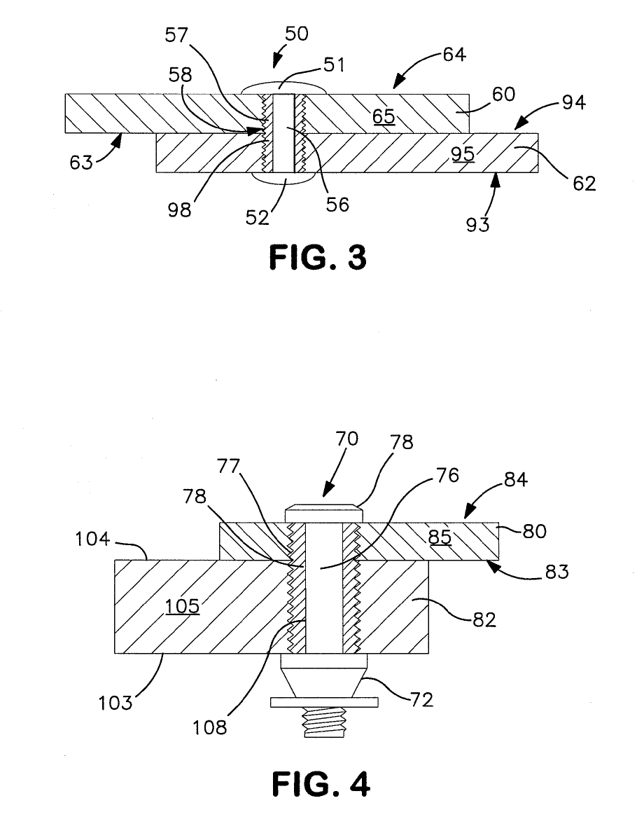

In another embodiment of the present invention, FIG. 3 shows a composite structure 60 and a second structure 62 substantially similar to that described above. In this embodiment, however, the fastener 50 is a metal structure (e.g., a rivet), or any other structure known to be used in the construction of aircraft. Thus, the composite structure 60 has an upper region 64, a lower region 63, and an interior region 65. The fastener 50 has a prefabricated head 51, a tail end 52, and fastener shank 56. In use, the rivet 50 would be installed according to standard industry practice. A conductive fluid 57 fills a contact area 58 between the shank 56 of the fastener 50 and the interior 65 of the composite structure 60. Additionally, if the second structure 62 is also a composite structure having an upper region 94, a lower region 93, and an interior region 95, then the conductive fluid 57 also fills the contact area 98 between the shank 56 of the fastener 50 and the interior 95 of the second structure 62.

In another embodiment of the present invention, with reference to FIG. 4, a fastener 70, can be a permanent fastener such as a Hi-Lok fastener produced by Hi-Shear Corporation, or any other permanent fastener which may be used in the construction of aircraft. FIG. 4 shows a composite structure 80 and a second structure 82, substantially similar to those described above. The composite structure 80 has an upper region 84, a lower region 83, and an interior region 85. In this embodiment, the Hi-Lok fastener 70 has a pin head 78, a shank 76, and a collar 72. In use, the Hi-Lok fastener 70 is installed according to standard industry practice. A conductive fluid 77 fills a contact area 78 between the shank 76 of the Hi-Lok fastener 70 and the interior 85 of the composite structure 80. Additionally, if the second structure 82 is also a composite structure having an upper region 104, a lower region 103, and an interior region 105, then the conductive fluid 77 also fills the contact area 108 between the shank 76 of the fastener 70 and the interior 105 of the second structure 82.

The individual components shown in outline or designated by blocks in the attached Drawings are all well-known in the arts of aircraft construction, and their specific construction and operation are not critical to the operation or best mode for carrying out the invention.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

All U.S. and foreign patents and patent applications discussed above are hereby incorporated by reference into the Detailed Description of the Preferred Embodiments.

What is claimed is:

1. A method for installing a grounding fastener in a composite aircraft structure, the method comprising the steps of:
drilling a hole in the composite aircraft structure, said hole dimensioned to provide a clearance fit with respect to the composite structure and the grounding fastener;
coating the grounding fastener with a conductive fluid;
inserting the grounding fastener into the hole such that the grounding fastener is in electrical contact with conductive fibers within the composite structure;
securing the grounding fastener to the composite structure; and
attaching a conductive device to the grounding fastener such that the conductive device is in electrical contact with the grounding fastener.

2. The method of claim 1, wherein the conductive fluid comprises an adhesive.

3. The method of claim 1, wherein the conductive fluid seeps into voids between fibers in an interior region of the conductive fiber.

4. A method for installing a grounding fastener, the method comprising the steps of:
providing a first structure comprising a composite material;
providing a second structure;
drilling a hole in the first and second structures, said hole dimensioned to provide a clearance fit with respect to the first structure and the grounding fastener;
coating the grounding fastener with a conductive fluid;
inserting the grounding fastener into the hole in the first structure such that the grounding fastener is in electrical contact with conductive fibers within the composite material of the first structure;
further inserting the grounding fastener into the hole in the second structure;
securing the grounding fastener to the first and second structures such that the first and second structures are secured to each other.

5. Aircraft composite structure grounding apparatus, comprising:
the aircraft composite structure having an upper surface, a lower surface, and an interior region, said interior region having a fastener hole therein, conductive composite fibers being disposed within said hole with a plurality of voids therebetween, said hole dimensioned to provide a clearance fit with respect to the composite structure and a grounding fastener;
the grounding fastener disposed within said fastener hole in the clearance fit with respect to the composite structure;
conductive fluid disposed in said fastener hole (i) to substantially fill the voids between the composite fiber and (ii) in electrical contact with said grounding fastener and said composite structure; and
a conductive element for conducting electrical charge away from said composite structure and said grounding fastener.
